(19) United States
(12) Patent Application Publication
(10) Pub. No.: US 2023/0068374 A1
(43) Pub. Date: Mar. 2, 2023

(54) USER RESPONSIVENESS TO EVENTS INDICATED BY NOTIFICATIONS

(71) Applicant: Citrix Systems, Inc., Fort Lauderdale, FL (US)

(72) Inventors: Wenshuang Zhang, Nanjing (CN); Xuan Liu, Nanjing (CN); Chunhui Wu, Nanjing (CN)

(21) Appl. No.: 17/468,018

(22) Filed: Sep. 7, 2021

Related U.S. Application Data
(63) Continuation of application No. PCT/CN2021/114414, filed on Aug. 25, 2021.

(51) Int. Cl. H04L 12/24

(52) U.S. Cl. CPC H04L 41/06

(57) ABSTRACT

A computing system may determine that first data received from a first system of record is indicative of a first event of the first system of record, and send a first notification indicative of the first event to a client device operated by a first user. The computing system may further determine that second data received from a second system of record is indicative of a second event for which the first user is to provide a response to the second system of record, send a second notification indicative of the second event to the client device, determine that the first user has not provided the response to the second system of record, and based at least in part on the first user not having provided the response to the second system of record, send a third notification indicative of the second event to the client device.

### CROSS-REFERENCE TO RELATED APPLICATIONS

This application is a continuation of and claims the benefit under 35 U.S.C. § 120 and 35 U.S.C. § 365(c) to International Application PCT/CN2021/114414, entitled IMPROVING USER RESPONSIVENESS TO EVENTS INDICATED BY NOTIFICATIONS, with an international filing date of Aug. 25, 2021, the entire contents of which are incorporated herein by reference for all purposes.

### BACKGROUND

Various systems have been developed that allow client devices to access applications and/or data files over a network. Some such systems provide users with notifications about events. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises determining, by a computing system, that first data received from a first system of record is indicative of a first event of the first system of record; sending, from the computing system to a client device operated by a first user, a first notification indicative of the first event; determining, by the computing system, that second data received from a second system of record is indicative of a second event for which the first user is to provide a response to the second system of record; sending, from the computing system to the client device, a second notification indicative of the second event; determining, by the computing system, that the first user has not provided the response to the second system of record; and based at least in part on the first user not having provided the response to the second system of record, sending, from the computing system to the client device, a third notification indicative of the second event.

In some embodiments, a method comprises determining that a first message addressed to a user includes text indicating that a response to the first message is sought; configuring a first notification of the first message to include information indicating that a response to the first message is sought; causing a client device operated by the user to present the first notification including the information; after the client device has presented the first notification including the information, determining that the user has not responded to the first message; and based at least in part on the user having not responded to the first message, causing the client device to present a second notification of the first message.

In some embodiments, a system comprises at least one processor and at least one computer-readable medium encoded with instruction which, when executed by the at least one processor, cause the system to determine that first data received from a first system of record is indicative of a first event of the first system of record, to send, to a client device operated by a first user, a first notification indicative of the first event, to determine that second data received from a second system of record is indicative of a second event for which a user is to provide a response to the second system of record, to send, to a client device operated by the user, a second notification indicative of the second event, to determine that the user has not provided the response to the second system of record, and to send, to the client device, a third notification indicative of the second event based at least in part on the user not having provided the response to the second system of record.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system for enhancing user responsiveness to events indicated by notifications in accordance with some aspects of the present disclosure;

FIG. 1B shows an example enhanced notification interface that may be presented by a display screen of the client device shown in FIG. 1A;

FIG. 1C shows an example window that may be presented when a user clicks on or otherwise selects one of the notifications shown in FIG. 1B;

FIG. 2 is a diagram of a network environment in which some embodiments of the context-based microapp action recommendation system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6 shows a first example routine that may be performed by the NRMS shown in FIG. 1A when new notifications of events are generated;

FIG. 7 shows an example table that may be populated and managed by the NRMS shown in FIG. 1A;

FIG. 8 shows a second example routine that may be performed by the NRMS shown in FIG. 1A to update the table shown in FIG. 7 when a user responds to an event indicated by an alarmed notification; and

FIG. 9 shows a third example routine that may be performed by the NRMS shown in FIG. 1A to update the table shown in FIG. 7 and trigger the sending of reminder notifications if the user does not respond to events indicated by alarmed notifications in a timely fashion.

### DETAILED DESCRIPTION

For purposes of reading the description of the various embodiments below, the following descriptions of the sections of the specification and their respective contents may be helpful:

Section A provides an introduction to example embodiments of a system for enhancing user responsiveness to events indicated by notifications in accordance with some aspects of the present disclosure;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F provides a more detailed description of example embodiments of the systems introduced in Section A; and

Section G describes example implementations of methods, systems/devices, and computer-readable media in accordance with the present disclosure.

### A. Introduction to Illustrative Embodiments of a System for Improving User Responsiveness to Events Indicated by Notifications

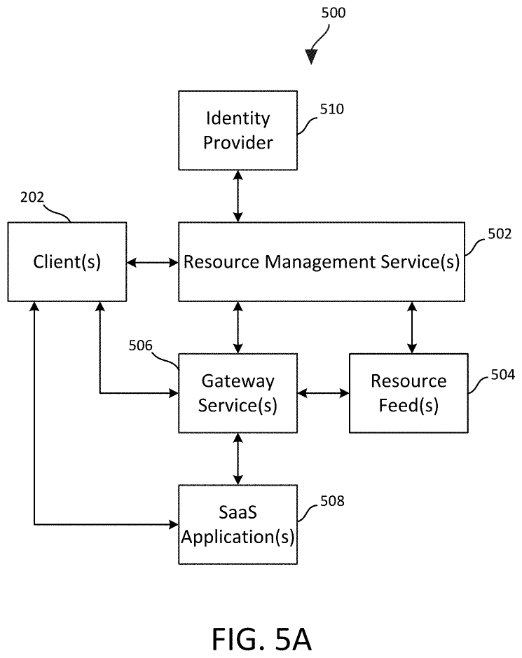

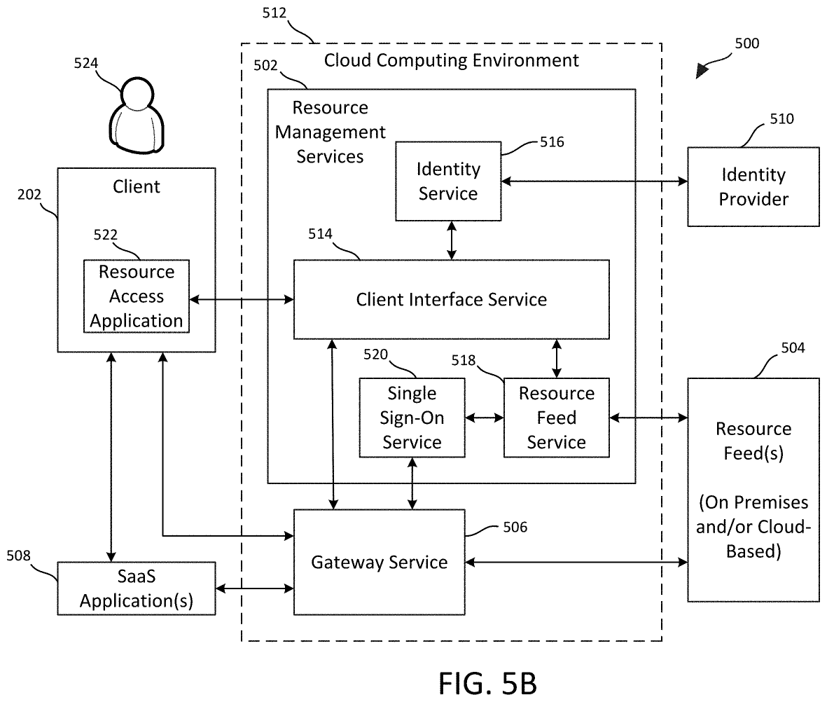

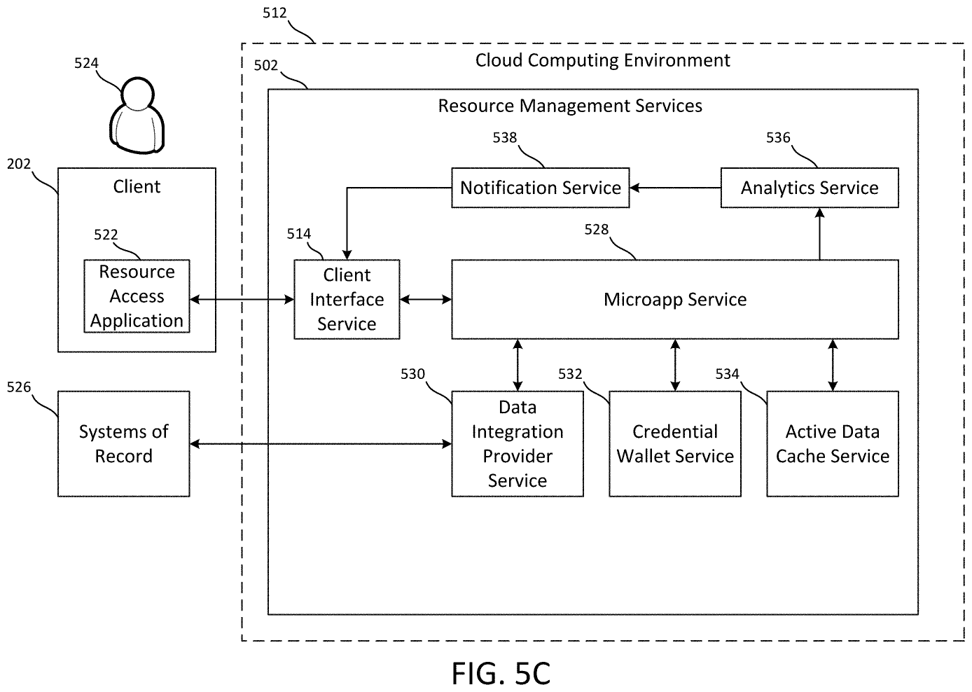

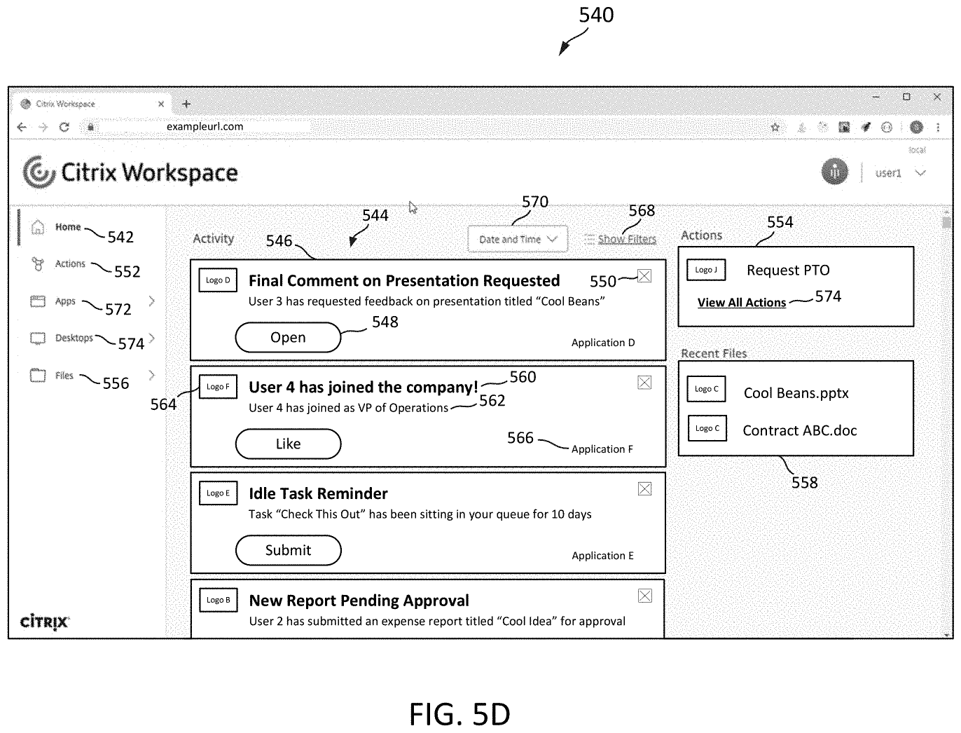

Various computer applications have been developed that notify users of events. For example, certain applications with messaging capabilities, such as Outlook, Slack, Teams, etc., notify users of messages received from other users of the same application. Such notifications may, for example, be presented as respective items within an “inbox” or other email folder, a message center, etc. A multi-resource access system, such as that offered by the Citrix Workspace™ family of products, may also notify users of events. For instance, as described below in Section E (in connection with FIGS. 5A-D), a multi-resource access system 500 may include a notification service 538 (show in FIG. 5C) that is configured to send event notifications 546 (shown in FIG. 5D) to a client device 202 for inclusion within an activity feed 544 presented by a resource access application 522. As Section E describes, the multi-resource access system 500 may be responsible for monitoring and interacting with various systems of record (e.g., Software-as-a Service (SaaS) applications, web applications, Windows applications, Linux applications, desktops, file repositories and/or file sharing systems, etc.) on behalf of a user 524 operating a client device 202, and may notify the user 524 of noteworthy events that occur within those systems of record 526.

More specifically, and as described in more detail in Section E, a microapp service 528 (shown in FIG. 5C) may periodically request a sync with a data integration provider service 530, so as to cause active data to be pulled from the systems of record 526. In some implementations, for example, the microapp service 528 may retrieve encrypted service account credentials for the systems of record 526 from a credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to an analytics service 536 for processing. The analytics service 536 may create notifications (e.g., targeted scored notifications) and send such notifications to the notification service 538. The notification service 538 may store the notifications in a database to be later served in an activity feed and/or may send the notifications out immediately to the client 202 as a push notification to the user 524.

FIG. 5D, which is also described in more detail in Section E, shows how a display screen 540 presented by the resource access application 522 (shown in FIG. 5C) may appear when an intelligent activity feed feature is employed and the user 524 is logged on to the system. As shown in FIG. 5D, the activity feed 544 may be presented on the display screen 540 that includes a plurality of notifications 546 about respective events that occurred within various applications to which the user 524 has access rights.

Effectively managing an email inbox or other event notification interface can be challenging. Some of the notifications on such a list may relate to events to which a user is expected to provide a response, such as responding to an email or other message asking a question, taking a responsive action with respect to a system of record (e.g., approving a paid time off (PTO) request), etc. Other notifications may be primarily informational, such as blog posts, new employee announcements, etc.

The inventors have recognized and appreciated that, even for the most diligent of users, notifications for which a response is expected can be readily overlooked or neglected within an event notification interface. This is particularly true for individuals who receive large volumes of notifications. Although marking notifications as “read” after they have been reviewed can help a user identify the notifications the user has not yet looked at, merely differentiating between read and unread notifications can actually increase the likelihood that a notification for which a response is expected will be overlooked. For example, a user may become distracted while viewing details of a particular notification or may not have time to provide the expected response at the time the notification is initially opened. While a user may recognize the need for a response and try to remember to provide it, the user may quickly be overwhelmed by other tasks and forget to provide the expected response. Meantime, the marking of the notification as read may discourage the user from accessing the notification on a subsequent occasion. Such “read” notifications may thus become stagnant in the user's notification interface, thus causing other individuals to become frustrated by the user's failure to provide the expected response.

Offered is a system that is capable of automatically identifying those notifications that relate to events for which a response is expected. In some implementations, such notifications may be marked, with a special icon or otherwise, to allow them to be readily differentiated from other types of notifications, such as informational notifications. Marking notifications in such a manner may significantly improve a user's ability to effectively respond to the needs of other individuals, by making it more difficult for such “response expected” event notifications to get overlooked or buried amongst other, less time-sensitive notifications. Further, in some implementations, the system may additionally or alternatively send one or more “reminder” notifications about events for which a response is expected. For example, in some implementations, such a reminder notification may be sent if the user has not provided the expected response within a threshold time period after receiving or viewing an initial notification concerning the event in question.

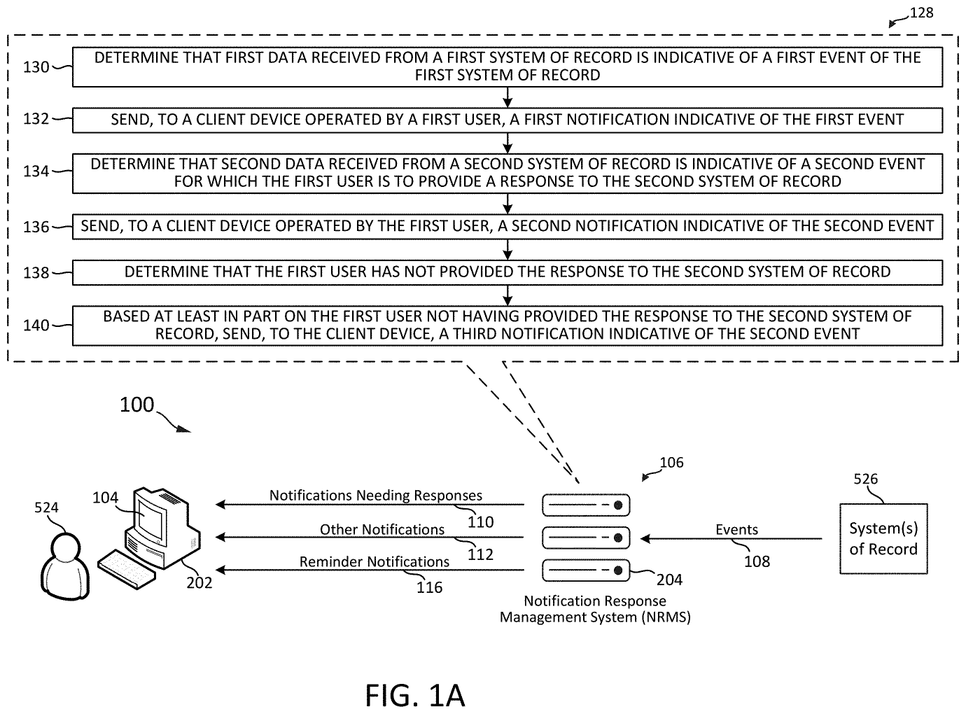

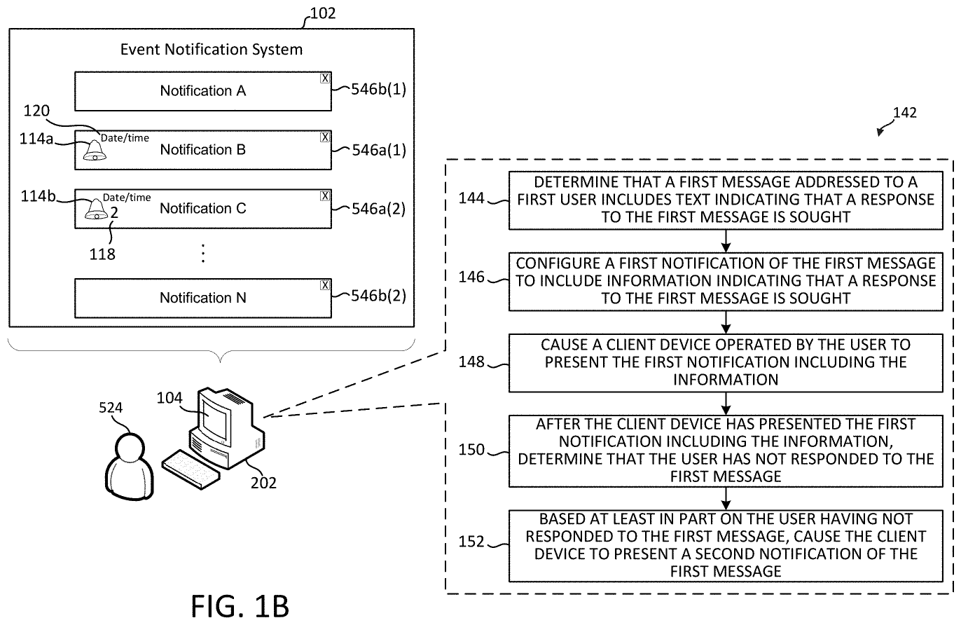

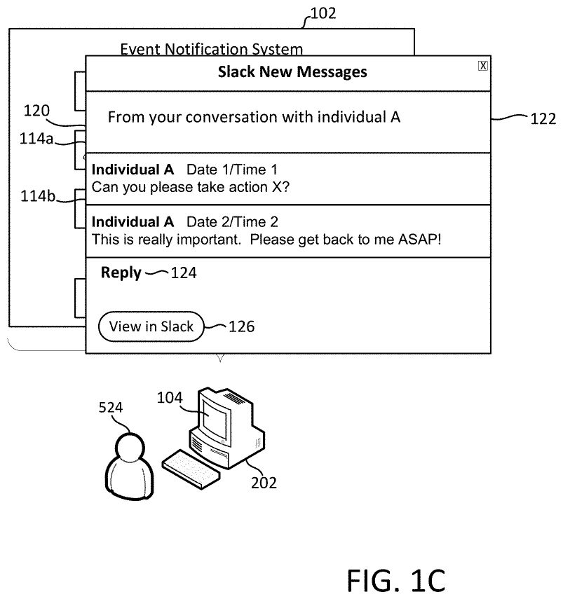

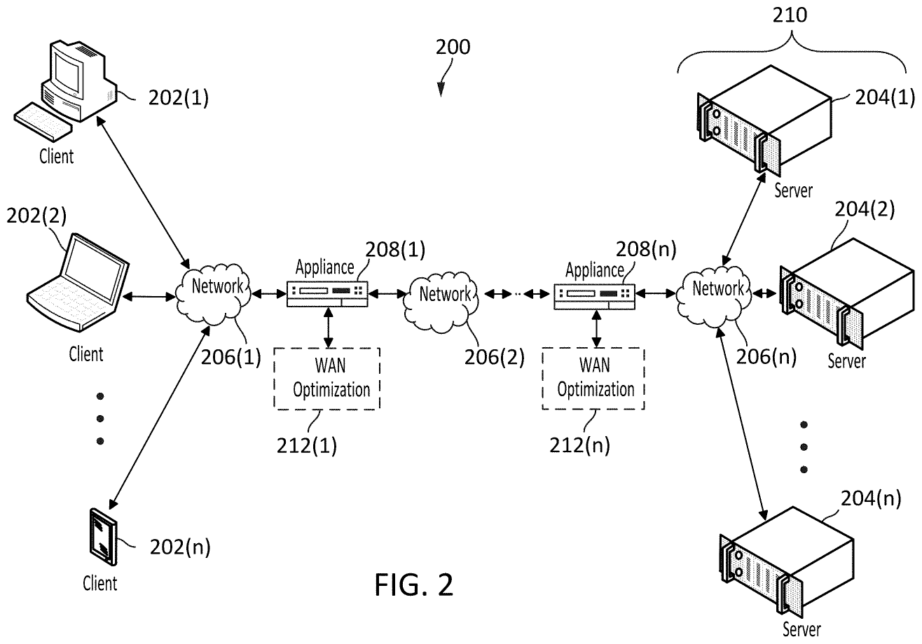

FIG. 1A shows an example system 100 configured in accordance with some embodiments of the present disclosure. FIG. 1B shows an example event notification interface 102 that may be presented by a display screen 104 of a client device 202 shown in FIG. 1A. FIG. 1C shows an example window 122 that may be presented when a user clicks on or otherwise selects one of the notifications 546 shown in FIG. 1B. As shown in FIG. 1A, in addition to the client device 202, the system 100 may include a notification response management system (NRMS) 106 and one or more systems of record 526. As illustrated, in some implementations, the NRMS 106 may include one or more servers 204. In some implementations, the NRMS 106 may communicate with the client device 202 and the system(s) of record 526 via one or more networks (not shown in FIG. 1A), such as the internet. Examples of client devices 202 and servers 204, as well as network environments 200 and/or cloud computing environments 400 in which such components can operate, are described below in connection with FIGS. 2-4. In some implementations, the NRMS 106 may be embodied by one or more processors and one or more computer-readable media encoded with instruction which, when executed by the at least one processor, cause the system 100 to perform the functionality described herein.

Examples of systems of record 526 are described below in connection with the multi-resource access system 500 shown in FIGS. 5A-D. In some implementations, the NRMS 106 may be included amongst the resource management service(s) 502 described in connection with FIGS. 5A-C. For example, in some implementations, the NRMS 106 may be included within, or operate in conjunction with, the analytics service 536 and/or the notification service 538. As Section E explains, the analytics service 536 may be responsible for generating targeted scored notifications 546, and the notification service 538 may be responsible for delivering those notifications 546 to client devices 202.

In other implementations, the NRMS 106 may instead be a part of, or operate in conjunction with, an application having messaging capabilities, such as Outlook, Slack, Teams, Jira, etc. In some implementations, for example, a system of record 526 may be a SaaS application with messaging capabilities, e.g., Outlook 365, and the functionality of the NRMS 106 may be included within such SaaS application. In other implementations, the NRMS 106 may be included within, or operate in conjunction with a component of a message exchange system, such an email server, e.g., a Microsoft Exchange server. In still other implementations, the NRMS 106 may be local to the client device 202 and/or may be embodied by one or more functional modules of the application responsible for presenting an event notification interface 102 via the client device 202, such as the resource access application 522, an email application or another application having inter-user messaging functionality, etc.

As indicated by an arrow 108 in FIG. 1A, the NRMS 106, wherever it happens to be located, may receive or otherwise access data indicative of events from the system(s) of record 526. In some implementations, the system(s) of record 526 may include one or more applications with messaging capabilities, such as Outlook, Slack, Teams, Jira, etc., and the received data may represent the content of one or more messages sent to and/or from an account of a user 524 of the client device 202. In some implementations, the system(s) of record 526 may additionally or alternatively include one or more applications that generate one or more tasks for the user 524, such as approving a PTO request via Workday, and the received data may represent the task(s) the user 524 is to complete.

In implementations in which the NRMS 106 is included amongst the resource management services 502 of FIGS. 5A-C, the data integration provider service 530 (or similar component) may use access credentials of the user 524 (e.g., retrieved from the credential wallet service 532) to retrieve data from such applications, e.g., via one or more application programming interface (API) calls, as described below in connection with FIG. 5C. Although the following description focuses primarily on the presentation of notifications 546 within an activity feed 544 for a multi-resource access system 500, it should be appreciated that many of the concepts and processes described herein are equally applicable to other types of notifications and notification interfaces, such as a listing of emails that are included in an inbox or other email folder.

The NRMS 106 may evaluate the event data (received per the arrow 108) and, based on that analysis, may cause the client device 202 to present two different types of notifications 546 within the event notification interface 102 (e.g., the activity feed 544 shown in FIG. 5D) on the display screen 104. In particular, as indicated by arrows 110 and 112 in FIG. 1A, and as shown in FIG. 1B, the NRMS 106 may distinguish between notifications 546a of events to which the user 524 is expected to respond (per the arrow 110) and notifications 546b of events to which the user is not expected to respond (per the arrow 112). In some implementations, the NRMS 106 may include information in the notifications 546a of the events to which a response is expected that informs the user 524 that such a response is expected. In the example event notification interface 102 shown in FIG. 1B, the added information includes respective alarm icons 114a, 114b. Although the term “alarmed notifications” will hereafter be used to refer to the notifications 546a that have been determined to relate to events to which a response by the user 524 is expected, that term is used solely for simplicity of description. It is not intended to indicate that the information presented within notifications needs to include an alarm icon or otherwise relates to an “alarm.” For example, in other implementations, the notifications 546a to which a response is expected may additionally or alternatively be identified using one or more different icons, one or more different colors, one or different text fonts or styles, highlighting, etc.

As noted above, and as indicated by an arrow 116 in FIG. 1A, in some implementations, the system 100 may send “reminder” notifications if the user 524 does not respond to alarmed notifications 546a in a timely fashion. For example, in some implementations, such a reminder notification may be sent if the user has not provided the expected response within a threshold time period (e.g., one day, three days, etc.) after receiving or viewing an earlier notification concerning the event in question. In some implementations, additional or different information may be included in at least some of the alarmed notifications 546a to indicate that they are being sent as reminders. As shown in FIG. 1B, for instance, the alarmed notification 546a(2) includes the numeral “2” (referred to herein as a reminder number indicator 118) adjacent the alarm icon 114b, whereas the alarmed notification 546a(1) does not include an accompanying numeral. The numeral “2” may indicate that the alarmed notification 546a(2) is the second notification 546 concerning an event that requires the user's attention, thus indicating that the alarmed notification 546a(2) is being sent as a reminder. The absence of a reminder number indicator 118 adjacent the alarm icon 114a (or perhaps inclusion of the numeral “1” as a reminder number indicator 118), on the other hand, may indicate that the alarmed notification 546a is the first notification 546 that has been presented relating to the event in question. Subsequent alarmed notifications 546a that are sent as reminders may similarly include numerals (e.g., “3,” “4,” “5,” etc.) indicting the total number of alarmed notifications 546a that have been previously been sent relating to the same event. In other implementations, the number of previously sent notifications may be indicated in other ways, such as by including a number of alarm icons 114a (e.g., two alarm icons 114, three alarm icons 114, etc.) corresponding to the total number of number of alarmed notifications 546a concerning the event that have been previously sent.

In some implementations, alarm icons 114 may be included in respective alarmed notifications 546a as soon as the NRMS 106 determines that responses are expected for the events indicated by those notifications. In other implementations, alarm icons 114 may be included in alarmed notifications 546a only after the user 524 initially views details of those notifications, e.g., by clicking on them, such as illustrated in FIG. 1C. As shown in FIG. 1C, in response to clicking on or otherwise selecting one of the notifications shown in FIG. 1B, additional information concerning the event for which the notification was generated may be presented in the window 122. In the illustrated example, the event to which the selected notification relates is a message another individual sent to the user via a Slack application. In some implementations, the window 122 may correspond to a microapp (e.g., enabled via the microapp service 528 described in connection with FIG. 5C), and may include a user interface element 124 enabling the user 524 to select an action to be taken indirectly (via the microapp) with respect to the system of record 526 (in this case responding to Slack message). Additionally or alternatively, the window 122 may include a user interface element 126 enabling the user 524 to access the system of record (in this case Slack) and respond to the indicated event directly within that system of record 526. In implementations in which notifications are marked as read after they are viewed, the additional information included in the alarmed notifications, e.g., an alarm icon 114, may inform the user 524 that a response is still expected to the events to which those notifications relate, even though they have been marked as read.

In some implementations, the additional information included in alarmed notifications 546a may additionally or alternatively include an a date/time indicator 120 to indicate a date and/or time at which another alarmed notification 546a will be sent if the user does not provide the expected response to the event to which the notification relates, e.g., by responding to a message, responding to a PTO request, etc.

FIG. 1A additionally shows an example routine 128 that may be performed by the NRMS 106 in accordance with some aspects of the present disclosure. As shown in FIG. 1A, at a step 130 of the routine 128, the NRMS 106 may determine that first data (e.g., as indicated by the arrow 108) received from a first system of record is indicative of a first event of the first system of record.

At a step 132 of the routine 128, the NRMS 106 may send a first notification (e.g., a notification 546 shown in FIG. 1B) indicative of the first event to the client device 202 operated by the first user 524.

At a step 134 of the routine 128, the NRMS 106 may determine that second data (e.g., as indicated by the arrow 108) received from a second system of record 526 is indicative of a second event (e.g., a message from another individual) for which the user 524 is to provide a response to the second system of record 526.

At a step 136 of the routine 128, the NRMS 106 may send a second notification (e.g., an alarmed notification 546a shown in FIG. 1B) indicative of the second event to the client device 202.

At a step 138 of the routine 128, the NRMS 106 may determine that the first user 524 has not provided the response to the second system of record 526. As discussed in more detail below, for example, the NRMS 106 may receive additional data from the system of record 526 and, based on that additional data, may determine whether the user 524 has provided the response.

At a step 140 of the routine 128, the NRMS 106 may, based at least in part on the first user not having provided the response to the second system of record 526, send a third notification (e.g., a reminder notification 546a(2)) indicative of the second event to the client device 202.

FIG. 1B shows another example routine 142 that may be performed by NRMS 106 in accordance with some aspects of the present disclosure. As noted above, in some implementations, the NRMS 106 may be included within the client device 202, e.g., as a part of a messaging application (e.g., Outlook) or otherwise. It should be appreciated, however, that in other implementations, the NRMS 106 may be located elsewhere in the system 100, such as illustrated in FIG. 1A.

As shown in FIG. 1B, at a step 144 of the routine 142, the NRMS 106 may determine that a first message (e.g., a first email, Slack message, etc.) includes text indicating that a response to the first message is sought. As discussed in more detail in Section F, for example, in some implementations, the NRMS 106 may identify one or more words or phrases, or patterns of words or phrases, in the text of the message that indicates the individual who sent the message expects the user 524 to reply to the message.

At a step 146 of the routine 142, the NRMS 106 may configure a first notification (e.g., a notification 546, an entry in an email inbox, etc.) to include information (e.g., an alarm icon 114) indicating that a response to the message is sought.

At a step 148 of the routine 142, the NRMS 106 may cause the client device 202 operated by the user 524 to present the first notification (e.g., a notification 546, an entry in an email inbox, etc.) including the information (e.g., an alarm icon 114).

At a step 150 of the routine 142, after the client device 202 has presented the first notification (e.g., a notification 546, an entry in an email inbox, etc.) including the information (e.g., an alarm icon 114), the NRMS 106 may determine that the user 524 has not responded to the first message (e.g., a first email, Slack message, etc.).

At a step 152 of the routine 142, the NRMS 106 may cause the client device 202 to present a second notification (e.g., a reminder notification 546a(2)) of the first message (e.g., a first email, Slack message, etc.) based at least in part on the user having not responded to the first message.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), interne protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

### C. Computing Environment

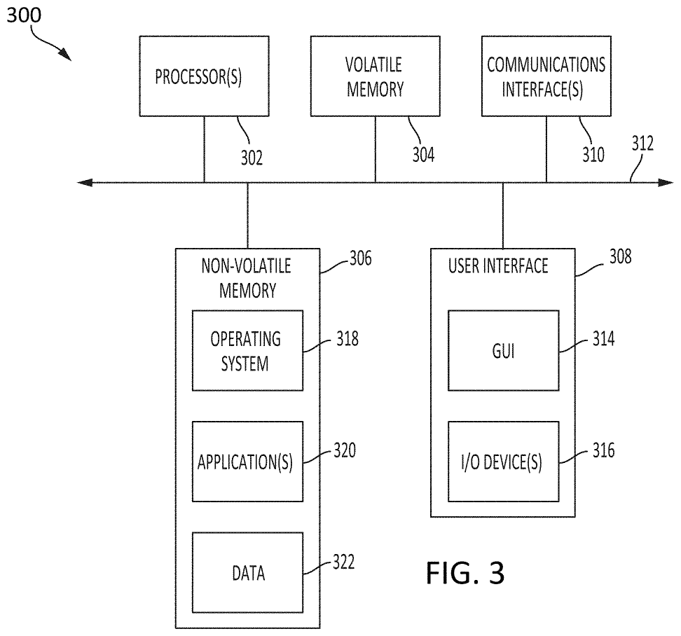

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

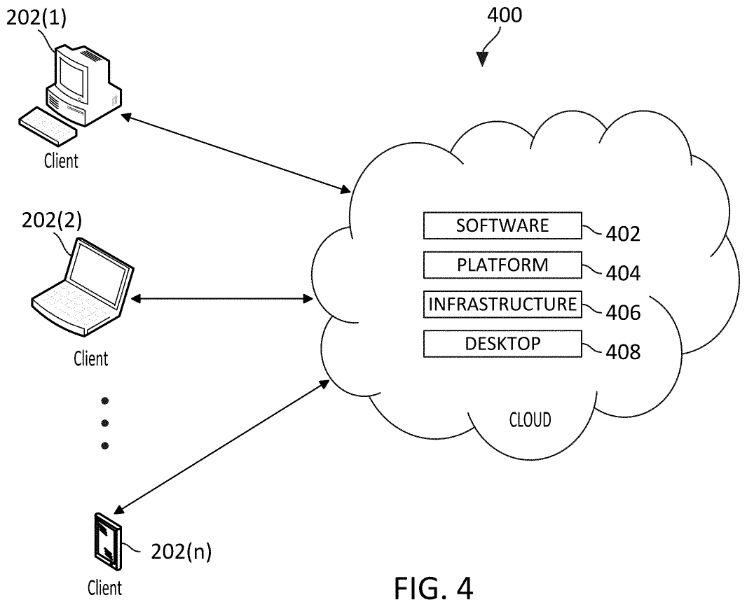

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Wash., Azure IaaS provided by Microsoft Corporation or Redmond, Wash., RACKSPACE CLOUD provided by Rackspace US, Inc., of San Antonio, Tex., Google Compute Engine provided by Google Inc. of Mountain View, Calif., and RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., ShareFile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource access application 522 is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence(AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and XML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system of record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of available microapp actions. In some implementations, the various microapp actions available to the user 524 logged onto the multi-resource access system 500 may be enumerated to the resource access application 522, e.g., when the user 524 initially accesses the system 500, and the list 554 may include a subset of those available microapp actions. The available microapp actions may, for example, be organized alphabetically based on the names assigned to the actions, and the list 554 may simply include the first several (e.g., the first four) microapp actions in the alphabetical order. In other implementations, the list 554 may alternatively include a subset of the available microapp actions that were most recently or most commonly accessed by the user 524, or that are preassigned by a system administrator or based on some other criteria. The user 524 may also access a complete set of available microapp actions, in a similar manner as the “action” user interface element 552, by clicking on the “view all actions” user interface element 574.

As shown, additional resources may also be accessed through the screen 540 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of a System for Improving User Responsiveness to Events Indicated by Notifications

Section A introduced a system 100 for evaluating data of one or more systems of record 526 to determine whether responses to events indicated by the data are expected (e.g., by responding to a message sent by another user, responding to a PTO request, etc.), and to include information in notifications about such events (e.g., notifications 546 in an activity feed 544, notifications in a an email inbox, etc.) indicating that the user to whom the notifications are provided is expected to respond to the events. As explained in Section A, the information included in such notifications may take on any of numerous forms, and may be presented in any of a number of ways. In the example implementation illustrated in FIG. 1B, for example, the information includes one or more alarm icons 114. As Section A notes, although such notifications of events to which a user response is expected are referred to herein as “alarmed notifications,” the term “alarmed” is used solely for simplicity of description. It is not intended to indicate that the information presented within notifications needs to include an alarm icon or otherwise relates to an “alarm.” For example, in other implementations, the notifications to which a response is expected may additionally or alternatively be identified using one or more different icons, one or more different colors, one or different text fonts or styles, highlighting, etc. Further, although the following description focuses primarily on the notifications 546 included in an activity feed 544 of a multi-resource access system 500 (such as described in connection with FIGS. 5A-D), it should be appreciated that many of the concepts and techniques are equally applicable to other types of systems that generate event notifications, such as a list of emails in an inbox presented by an email application (e.g., Outlook), a list of messages presented by another application with inter-user messaging capabilities (e.g., Teams, Jira, etc.), or otherwise.

As also described in Section A, in some implementations, if the user 524 does not respond to the event indicated by an alarmed notification 546a in a timely fashion, the system may provide one or more reminder notifications to the user 524. The alarmed notification 546a(2) shown in FIG. 1B is an illustrative example of such a reminder notification.

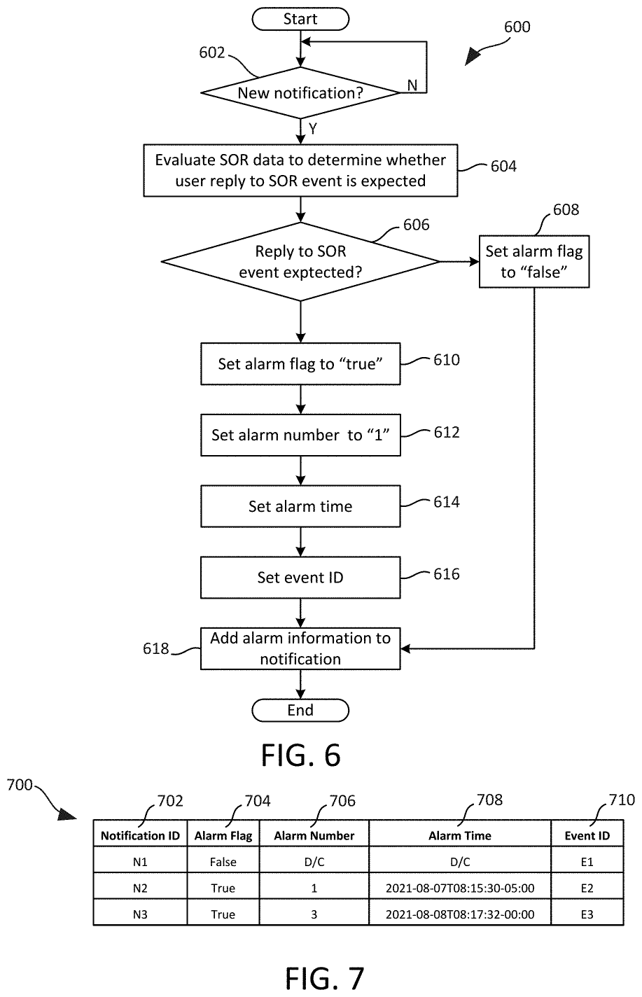

FIG. 6 is a flowchart showing a first example routine 600 that may be executed by the NRMS 106 shown in FIG. 1A. As noted previously, in some implementations, the NRMS 106 may be included within, or operate in conjunction with the analytics service 536 shown in FIG. 5C. As Section E describes, the microapp service 528 (also shown in FIG. 5C) may send data concerning events of the systems of record 526 to the analytics service 536 for processing. The analytics service 536 may create notifications 546 (e.g., targeted scored notifications) and send such notifications 546 to the notification service 538. The notification service 538 may store the notifications 546 in a database to be later served in an activity feed and/or may send the notifications 546 out immediately to the client 202 as a push notification to the user 524.

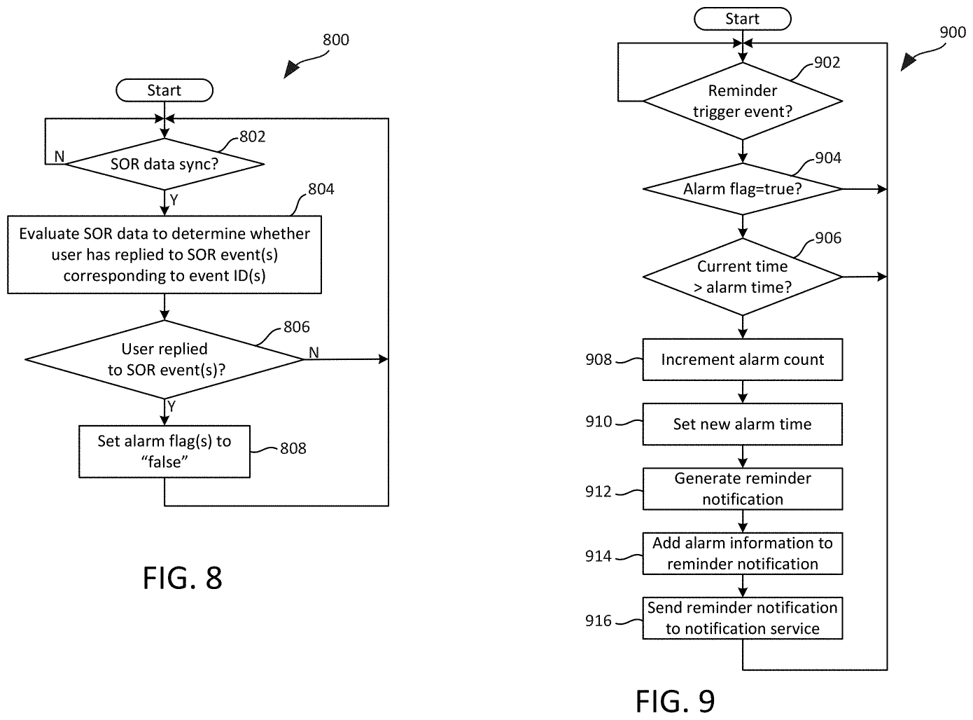

Pursuant to the routine 600, the NRMS 106 may further evaluate the data obtained from the systems of record 526 to determine whether the notifications 546 the analytics service generates relate to events to which a user response is expected. As described below, in some implementations, the analytics service 536 may populate a table 700 (shown in FIG. 7) based on such analysis. In some implementations, the data included in the table 700 may be appended, e.g., as one or more additional columns, to table data the analytics service 536 separately generates for the notifications 546 it sends to the notification service 538. In other implementations, the table 700 may be separate from such other table data. In any event, as explained below, the data included in the table 700 may be used to determine whether a particular notification is an alarmed notification 546a, and thus whether an alarm icon 114 or the like is to be included in it, and may also be used to determine whether to generate one or more reminder notifications 546a(2) if a user does not respond in a timely fashion to the event to which the alarmed notification 546a relates. As described below, for example, in some implementations, the analytics service 536 (or other instantiation of the NRMS 106) may perform a routine 800 (shown in FIG. 8) to determine (periodically or otherwise) whether the user 524 has responded to the event in question and to update the table 700 accordingly, and may further perform a routine 900 (shown in FIG. 9) to determine whether to generate a reminder notification 546a(2) relating to the event for the user 524 based on the current content of the table 700.

Referring to FIG. 6, the routine 600 may begin at a decision step 602, at which the NRMS 106 may determine whether a new notification 546 has been, or is in the process of being, generated, e.g., by the analytics service 536. As indicated, the routine 600 may proceed to a step 604 when the NRMS 106 determines that a new notification 546 has been or is in the process of being generated.

At the step 604, the NRMS 106 may evaluate the data (obtained from a system of record 526) on which the new notification 546 is based to determine whether a response to the event to which the notification relates is expected. In some implementations, the step 604 may involve the evaluation of the content of a message sent to the user 524 by another individual via a messaging application. For example, in implementations based on the multi-resource access system 500 described in Section E, the data integration provider service 530 (shown in FIG. 5C) may have used the authentication credentials of the user 524 (e.g., obtained from the credential wallet service 532) to perform a data synchronization operation with a server-based messaging application, e.g., Outlook 365, to obtain data representing messages that have been sent to or from an account of the user 524. Alternatively, in implementations in which the NRMS 106 is included within an application with messaging capabilities, the NRMS 106 may simply evaluate the content of the various messages that have been sent to the user 524 by other individuals to determine whether that content indicates that a response to the message is expected.

Any of a number of techniques may be employed to determine whether the content of a particular message indicates that a response by the user 524 is expected. In some implementations, for example, the text of the message may be evaluated to determine whether one or more words or phrases, or patterns of words or phrases, are present in the text. For instance, the presence of an interrogative word, such as “what,” “why,” “how,” “when,” “who,” “which” preceding a descriptive word or phrase, and possibly followed by a question mark, may be determined to be indicative of message to which a response is expected. As another example, the presence of one or more words that indicate solicitation of a yes/no answer, such as “could,” “can,” or “would,” followed by the term “you,” may be determined to be indicative of message to which a response is expected. In other implementations, one or more machine learning models may be trained to recognize messages to which responses are expected.

In some implementations, the step 604 may alternatively involve the evaluation of data (obtained from a system of record 526) indicative of an event other than a message sent by another individual. For example, in implementations based on the multi-resource access system 500 described in Section E, the data integration provider service 530 (shown in FIG. 5C) may have used the authentication credentials of the user 524 (e.g., obtained from the credential wallet service 532) to perform a data synchronization operation with a human resources SaaS application, e.g., Workday, to obtain one or more tables or other data associated with an account of the user 524. Based on that data, the NRMS 106 may evaluate the data that triggered the generation of a particular notification and determine whether that data indicates that the user 524 is expected to provide a response to the application, such as approving a PTO request for an employee.

At a decision step 606 of the routine 600, the NRMS 106 may determine whether, pursuant to the processing performed at the step 604, a response is expected to the event to which the new notification 546 relates. When, at the decision step 606, the NRMS 106 determines that a response is not expected to the event to which the new notification 546 relates, the routine 600 may proceed to a step 608, at which an “alarm flag” entry 704 for the new notification 546 may be set to “false.” As shown in FIG. 7, the new notifications may be assigned notification identifiers (IDs) (e.g., when they are generated by the analytics service), and the “alarm flag” entries 704 may be written to the table 700 in association with such notification IDs.

When the NRMS 106 determines (at the decision step 606) that a response is expected to the event to which the new notification 546 relates, the routine 600 may instead proceed to a step 610, at which an “alarm flag” entry 704 for the new notification 546 may be set to “true.” As discussed below in connection with a step 618, the setting of an “alarm flag” entry 704 for a notification 546 to “true” may serve to designate the notification as an alarmed notification 546a, and, as such, may trigger the NRMS 106 to add information (e.g., an alarm icon 114) to the notification 546 that indicates it relates to an event to which a response is expected.

At a step 612 of the routine 600, the NRMS 106 may set an “alarm number” entry 706 for the new notification in the table 700 to “1,” thus indicating that the new notification 546 is the first alarmed notification 546a that is to be sent to the user 524 relating to the event. As discussed in more detail below, the setting of the “alarm number” entry 706 to “1” and subsequent incrementing of that value as reminder notifications 546a(2) are generated may allow the NRMS 106 to include information (e.g., such as the reminder number indicator 118 shown in FIG. 1B) in an alarmed notification 546a indicating the total number of alarmed notifications 546a that have thus far been presented to the user 524 relating to the event in question.

At a step 614 of the routine 600, the NRMS 106 may set the “alarm time” entry 708 for the new notification 546 in the table 700 to a date and/or time in the future at which a reminder notification 546a(2) is to be sent if the user 524 does not respond to the event indicated by the new notification 546. In some implementations, suitable alarm times for particular types of notifications may be determined in advance by a system of administrator and/or the user 524, e.g., by accessing and adjusting user-specific settings for such alarm times. Alternatively, in some implementations, one or more machine learning models may be trained to identity suitable alarm times based on monitored interactions of the user 524 with alarmed notifications 546a.

As discussed in more detail below, in some implementations, the NRMS 106 may use the “alarm time” entries 708 to include information (e.g., the date/time indicator 120 shown in FIG. 1B) in alarmed notifications 546a indicating the dates and/or times at which reminder notifications 546a(2) are to be sent if the user 524 does not respond to the events indicated by respective alarmed notifications 546a.

In some implementations, the system 100 may be configured to allow the user 524 to adjust the “alarm time” entries of respective alarmed notifications 546a, such as by right-clicking on or otherwise selecting a date/time indicator 120 on an alarmed notification 546a and entering and/or selecting a new date and/or time at which a reminder notification 546a(s) is to be sent. In some implementations, for example, the resource access application 522 (shown in FIGS. 5B-C) may enable such user interactions with the alarmed notifications 546a, and may send adjusted dates/times for alarmed notifications 546a to the NRMS 106 for recording as revised “alarm time” entries 708 in the table 700 for the user 524. In some implementations, such user adjustments of the “alarm time” entries 708 may be used to modify previously determined alarm time settings for particular types of notifications and/or to re-train a machine learning model used to determine suitable “alarm time” entries 708.

At a step 616 of the routine 600, the NRMS 106 may determine an event identifier (ID) corresponding to the “notification ID” entry 702 in the table 700, and may write such an event ID as an “event ID” entry 710 in the table 700. As explained in more detail below in connection with the routine 800 shown in FIG. 8, the “event ID” entry 710 may subsequently be used by the NRMS 106 to determine whether the user 524 has responded to a particular event of a system of record 526, such as a particular message sent by another individual using an application with messaging capabilities (e.g., Outlook, Slack, Jira, etc.), a particular action to be taken (e.g., approval of a particular PTO request) with respect to a particular system of record (e.g., Workday), etc. The “event ID” entry 710 may thus represent a message identifier, a request identifier, or another identifier, depending on the nature of the event to which a response is to be provided to a system of record 526.

At a step 618 of the routine 600, the NRMS 106 may add one or more pieces of alarm-related information to the newly identified alarmed notification 546a. As noted previously with reference to FIG. 1B, examples of such alarm-related information that may added include one or more alarm icons 114, a reminder number indicator 118 indicating the total number of alarmed notifications 546a that have thus far been presented to the user 524, and a date/time indicator 120 indicating a date and/or time at which a reminder notification 546a(2) will be sent absent a response to the event by the user 524. After the alarm-related information has been added to the notification 546, the resulting alarmed notification 546a may be presented to the user 524, such as by sending the alarmed notification 546a to the notification service 538 for delivery to the resource access application 522 of the client device 202, in the manner described in Section E.

FIG. 8 shows another example routine 800 that may be performed by the NRMS 106 upon receipt of additional data from one or more systems of record 526, such as when the data integration provider service 530 (shown in FIG. 5C) performs a data synchronization operation with the system(s) of record 526. As shown in FIG. 8, upon the NRMS 106 determining that a data synchronization has been performed with one or more of the systems of record 526, the routine may proceed to a step 804, at which the data received from the system(s) of record 526 may be evaluated to determine whether the user has replied to the system of record events identified by the “event ID” entries 710 in the table 700. For example, if the event that triggered the generation of an alarmed notification 546a was a message sent by another individual via an application with messaging capabilities (e.g., Slack), the NRMS 106 may determine whether data received from that application indicates that the user 524 has responded to the message in question. In some implementations, the text of a reply message may be evaluated to confirm that it is actually responsive to the message that triggered the alarmed notification, as opposed to simply acknowledging its receipt (e.g., “I'll look into that and get back to you soon.”). As another example, if the event that triggered the generation of an alarmed notification 546a was submission of a PTO request, the NRMS 106 may determine whether data received from that application indicates that the user 524 has responded to that PTO request.

When, at a decision step 806, the NRMS 106 determines that the user has replied to one or more events indicated by the “event ID” entries 710 in the table 700, the routine may proceed to a step 808, at which the NRMS 106 may set the “alarm flag” entries 704 for the alarmed notification(s) 546a corresponding to such “event ID” entries 710 to “false,” thus effectively removing the “alarmed” status for such notification(s) 546. When, on the other hand, the NRMS 106 determines that the user has not replied to any events indicated by the “event ID” entries 710 in the table 700, the routine may instead return to the step 802, at which the NRMS 106 may await new data from the system(s) of record 526.

FIG. 9 shows another example routine 900 that may be performed by the NRMS 106, periodically or otherwise, to determine whether to generate and/or how to configure reminder notifications 546a(2) relating to events to which the user 524 has not yet responded. As shown in FIG. 9, the routine 900 may begin upon the NRMS 106 determining (e.g., at a decision step 902) that a trigger event for sending reminder notifications has occurred. In some implementations, such a trigger event may simply be the elapsing of a particular period of time, e.g., a trigger event may occur once per second, once per minute, once per hour, etc. In other implementations, a trigger event may additionally or alternatively include an action taken by the user 524 of the resource access application 522, and/or may include a detected event within the system 100, such as the completion of a data synchronization event via the data integration provider service 530.

Once such a triggering event has occurred, the routine 900 may proceed to a decision steps 904 and 906, at which the NRMS 106 may evaluate the data in the table 700 for individual notifications (e.g., rows corresponding to respective “notification ID” entries 702) to identify those rows for which both (A) the “alarm flag” entry 704 is “true,” and (B) the current date and/or time, e.g., determined by a calendar and/or clock of the NRMS 106, is greater than the date and/or time indicated by the corresponding “alarm time” entry 708. The NRMS 106 may determine to send a reminder notification 546a(2) in response to determining that both such conditions are met for the data in a given row. The remainder of the steps of the routine 900 may be performed by the NRMS 106 in response to the NRMS 106 determining (per the decision steps 902 and 904) to send a reminder notification 546a(2).

At a step 908 of the routine 900, the NRMS 106 may increment the value of the “alarm number” entry 706 corresponding to the “notification ID” entry 702 for which a reminder notification is to be sent. With reference to the table 700 of FIG. 7, for example, the NRMS 106 may increment the value of the “alarm number” entry 706 corresponding to the “notification ID” entry 702 from “1” to “2.” As noted above, the value of the “alarm number” entry 706 may serve to indicate the total number of notifications 546 concerning an event that have been sent to the user 524. Incrementing the “alarm number” entry 706 from “1” to “2” may thus indicate that the reminder notification 546a(2) that is to be sent (per a step 916 of the routine 900, as described below) will be the second notification concerning the event in question that the user 524 will be receiving. As noted previously, in some implementation, information indicating the total number of notifications that have been sent concerning an event, e.g., the reminder number indicator 118 shown in FIG. 1B, may be included in a reminder notification 546a(2) about such event.

At a step 910 of the routine 900, the NRMS 106 may set a new value for the “alarm time” entry 708 corresponding to the “notification ID” entry 702 for which a reminder notification is to be sent. In some implementations, for example, the NRMS 106 may increment the current value of the “alarm time” entry 708 by a particular amount, e.g., twelve hours, two days, one week, etc. Once the “alarm time” entry 708 has been incremented or otherwise revised, the NRMS 106 may use the updated date and/or time to determine whether to send yet another reminder notification to the user during a subsequent iteration of the routine 900. In some implementations, the amount by which the value of the “alarm time” entry 708 is incremented may be determined based on user preferences, e.g., associated with a profile of the user 524, and/or based on evaluation of the user's historical interactions with alarmed notifications 546a.

At a step 912 of the routine 900, the NRMS 106 may generate a reminder notification 546a(2) for the event in question, and, at a step 914 of the routine 900, the NRMS 106 may add one or more items of alarm-related information to the generated reminder notification 546a(2). As discussed above in connection with FIG. 1B, for example, in some implementations, the information the NRMS 106 adds to the generated reminder notification 546a(2) may include an alarm icon 114, a reminder number indicator 118, and/or a date/time indicator 120.

At the step 914 of the routine 900, the NRMS 106 may send the generated reminder notification 546a(2), which has been enhanced with alarm-related information, to the notification service 538 (shown in FIG. 5C) for delivery to the resource access application 522 of the client device 202.

The above described embodiments may greatly enhance a user's ability to respond to events of one or more systems of record, both by (A) including information in notifications about such events to indicate that responses to such events are expected, and (B) providing reminder notifications about such events if the user does not provide the expected response in a timely fashion.

### G. Example Implementations of Methods, Systems, and Computer-Readable Media in Accordance with the Present Disclosure

The following paragraphs (M1) through (M13) describe examples of methods that may be implemented in accordance with the present disclosure.

(M1) A method may be performed that involves determining, by a computing system, that first data received from a first system of record is indicative of a first event of the first system of record; sending, from the computing system to a client device operated by a first user, a first notification indicative of the first event; determining, by the computing system, that second data received from a second system of record is indicative of a second event for which the first user is to provide a response to the second system of record; sending, from the computing system to the client device, a second notification indicative of the second event; determining, by the computing system, that the first user has not provided the response to the second system of record; and based at least in part on the first user not having provided the response to the second system of record, sending, from the computing system to the client device, a third notification indicative of the second event.

(M2) A method may be performed as described in paragraph (M1), and may further involve, prior to sending the third notification to the client device, configuring, by the computing system, the second notification to include information indicating that a response to the second system of record is sought.

(M3) A method may be performed as described in paragraph (M2), and may further involve determining that the first user viewed content of the second notification, and configuring the second notification to include the information based at least in part on the first user having viewed the content.

(M4) A method may be performed as described in paragraph (M2) or paragraph (M3), and may further involve determining that a threshold period of time has elapsed after configuring the second notification to include the information, and sending the third notification to the client device based at least in part on the threshold period of time having elapsed.

(M5) A method may be performed as described in any of paragraphs (M1) through (M4), wherein the second system of record may be a messaging application with which the first user has an account, the second event may comprise receipt of a first message from a second user via the messaging application, and the second data may represent the first message.

(M6) A method may be performed as described in paragraph (M5), wherein determining that second data is indicative of the second event may involve determining that text of the first message indicates that the second user has requested the response by the first user.

(M7) A method may be performed as described in paragraph (M5) or paragraph (M6), wherein determining that the first user has not provided the response to the second system of record may involve receiving, by the computing system, third data received from the second system of record, the third data indicative of second messages sent by the first user via the messaging application, and determining that none of the second messages represents the response by the first user.

(M8) A method may be performed as described in any of paragraphs (M1) through (M7), and may further involve determining that a threshold period of time has elapsed after sending the second notification to the client device, and determining to send the third notification to the client device based at least in part on the threshold period of time having elapsed.

(M9) A method may be performed as described in any of paragraphs (M1) through (M8), and may further involve configuring, by the computing system, the second notification to include information indicating that another notification indicative of the second event will be sent if the first user does not provide the response to the second system of record.

(M10) A method may be performed that involves determining that a first message addressed to a user includes text indicating that a response to the first message is sought; configuring a first notification of the first message to include information indicating that a response to the first message is sought; causing a client device operated by the user to present the first notification including the information; after the client device has presented the first notification including the information, determining that the user has not responded to the first message; and based at least in part on the user having not responded to the first message, causing the client device to present a second notification of the first message.

(M11) A method may be performed as described in paragraph (M10), and may further involve configuring the first notification to include information indicating that another notification of the first message will be sent if the user does not provide the response to the first message.

(M12) A method may be performed as described in paragraph (M10) or paragraph (M11), and may further involve determining that the user viewed content of the first notification, and configuring the first notification to include the information based at least in part on the user having viewed the content.

(M13) A method may be performed as described in any of paragraphs (M10) through (M12), wherein determining that the user has not responded to the first message may further involve identifying second messages sent by the user via a messaging application, and determining that none of the second messages represents the response by the user.

The following paragraphs (S1) through (S13) describe examples of systems and devices that may be implemented in accordance with the present disclosure.

(S1) A system may comprise at least one processor and at least one computer-readable medium encoded with instruction which, when executed by the at least one processor, cause the system to determine that first data received from a first system of record is indicative of a first event of the first system of record, to send, to a client device operated by a first user, a first notification indicative of the first event, to determine that second data received from a second system of record is indicative of a second event for which a user is to provide a response to the second system of record, to send, to the client device, a second notification indicative of the second event, to determine that the user has not provided the response to the second system of record, and to send, to the client device, a third notification indicative of the second event based at least in part on the user not having provided the response to the second system of record.

(S2) A system may be configured as described in paragraph (S1), and the at least one computer-readable medium may be further encoded with additional instructions which, when executed by the at least one processor, further cause the system to configure, prior to sending the third notification to the client device, the second notification to include information indicating that a response to the second system of record is sought.

(S3) A system may be configured as described in paragraph (S2), and the at least one computer-readable medium may be further encoded with additional instructions which, when executed by the at least one processor, further cause the system to determine that the first user viewed content of the second notification, and to configure the second notification to include the information based at least in part on the first user having viewed the content.

(S4) A system may be configured as described in paragraph (S2) or paragraph (S3), and the at least one computer-readable medium may be further encoded with additional instructions which, when executed by the at least one processor, further cause the system to determining that a threshold period of time has elapsed after configuring the second notification to include the information, and sending the third notification to the client device based at least in part on the threshold period of time having elapsed.

(S5) A system may be configured as described in any of paragraphs (S1) through (S4), wherein the second system of record may be a messaging application with which the first user has an account, the second event may comprise receipt of a first message from a second user via the messaging application, and the second data may represent the first message.

(S6) A system may be configured as described in paragraph (S5), and the at least one computer-readable medium may be further encoded with additional instructions which, when executed by the at least one processor, further cause the system to determine that second data is indicative of the second event at least in part by determining that text of the first message indicates that the second user has requested the response by the first user.

(S7) A system may be configured as described in paragraph (S5) or paragraph (S6), and the at least one computer-readable medium may be further encoded with additional instructions which, when executed by the at least one processor, further cause the system to determine that the first user has not provided the response to the second system of record at least in part by receiving, by the computing system, third data received from the second system of record, the third data indicative of second messages sent by the first user via the messaging application, and determining that none of the second messages represents the response by the first user.

(S8) A system may be configured as described in any of paragraphs (S1) through (S7), and the at least one computer-readable medium may be further encoded with additional instructions which, when executed by the at least one processor, further cause the system to determine that a threshold period of time has elapsed after sending the second notification to the client device, and to determine to send the third notification to the client device based at least in part on the threshold period of time having elapsed.

(S9) A system may be configured as described in any of paragraphs (Si) through (S8), and the at least one computer-readable medium may be further encoded with additional instructions which, when executed by the at least one processor, further cause the system to configure the second notification to include information indicating that another notification indicative of the second event will be sent if the first user does not provide the response to the second system of record.

(S10) A system may comprise at least one processor and at least one computer-readable medium encoded with instruction which, when executed by the at least one processor, cause the system to determine that a first message addressed to a user includes text indicating that a response to the first message is sought, to configure a first notification of the first message to include information indicating that a response to the first message is sought, to cause a client device operated by the user to present the first notification including the information, to determine, after the client device has presented the first notification including the information, that the user has not responded to the first message, and to cause the client device to present a second notification of the first message based at least in part on the user having not responded to the first message.

(S11) A system may be configured as described in paragraph (S10), and the at least one computer-readable medium may be further encoded with additional instructions which, when executed by the at least one processor, further cause the system to configure the first notification to include information indicating that another notification of the first message will be sent if the user does not provide the response to the first message.

(S12) A system may be configured as described in paragraph (S10) or paragraph (S11), and the at least one computer-readable medium may be further encoded with additional instructions which, when executed by the at least one processor, further cause the system to determine that the user viewed content of the first notification, and to configure the first notification to include the information based at least in part on the user having viewed the content.

(S13) A system may be configured as described in any of paragraphs (S10) through (S12), and the at least one computer-readable medium may be further encoded with additional instructions which, when executed by the at least one processor, further cause the system to determine that the user has not responded to the first message at least in part by identifying second messages sent by the user via a messaging application, and determining that none of the second messages represents the response by the user.

The following paragraphs (CRM1) through (CRM13) describe examples of computer-readable media that may be implemented in accordance with the present disclosure.

(CRM1) At least one non-transitory computer-readable medium encoded with instruction which, when executed by at least one processor of a system, cause the system to determine that first data received from a first system of record is indicative of a first event of the first system of record, to send, to a client device operated by a first user, a first notification indicative of the first event, to determine that second data received from a second system of record is indicative of a second event for which a user is to provide a response to the second system of record, to send, to the client device, a second notification indicative of the second event, to determine that the user has not provided the response to the second system of record, and to send, to the client device, a third notification indicative of the second event based at least in part on the user not having provided the response to the second system of record.

(CRM2) At least one non-transitory computer-readable medium may be configured as described in paragraph (CRM1), and may be further encoded with additional instructions which, when executed by the at least one processor, further cause the system to configure, prior to sending the third notification to the client device, the second notification to include information indicating that a response to the second system of record is sought.

(CRM3) At least one non-transitory computer-readable medium may be configured as described in paragraph (CRM2), and may be further encoded with additional instructions which, when executed by the at least one processor, further cause the system to determine that the first user viewed content of the second notification, and to configure the second notification to include the information based at least in part on the first user having viewed the content.

(CRM4) At least one non-transitory computer-readable medium may be configured as described in paragraph (CRM2) or paragraph (CRM3), and may be further encoded with additional instructions which, when executed by the at least one processor, further cause the system to determining that a threshold period of time has elapsed after configuring the second notification to include the information, and sending the third notification to the client device based at least in part on the threshold period of time having elapsed.

(CRM5) At least one non-transitory computer-readable medium may be configured as described in any of paragraphs (CRM1) through (CRM4), wherein the second system of record may be a messaging application with which the first user has an account, the second event may comprise receipt of a first message from a second user via the messaging application, and the second data may represent the first message.

(CRM6) At least one non-transitory computer-readable medium may be configured as described in paragraph (CRM5), and may be further encoded with additional instructions which, when executed by the at least one processor, further cause the system to determine that second data is indicative of the second event at least in part by determining that text of the first message indicates that the second user has requested the response by the first user.

(CRM7) At least one non-transitory computer-readable medium may be configured as described in paragraph (CRM5) or paragraph (CRM6), and may be further encoded with additional instructions which, when executed by the at least one processor, further cause the system to determine that the first user has not provided the response to the second system of record at least in part by receiving, by the computing system, third data received from the second system of record, the third data indicative of second messages sent by the first user via the messaging application, and determining that none of the second messages represents the response by the first user.

(CRM8) At least one non-transitory computer-readable medium may be configured as described in any of paragraphs (CRM1) through (CRM7), and may be further encoded with additional instructions which, when executed by the at least one processor, further cause the system to determine that a threshold period of time has elapsed after sending the second notification to the client device, and to determine to send the third notification to the client device based at least in part on the threshold period of time having elapsed.

(CRM9) At least one non-transitory computer-readable medium may be configured as described in any of paragraphs (CRM1) through (CRM8), and may be further encoded with additional instructions which, when executed by the at least one processor, further cause the system to configure the second notification to include information indicating that another notification indicative of the second event will be sent if the first user does not provide the response to the second system of record.

(CRM10) At least one non-transitory computer-readable medium encoded with instruction which, when executed by at least one processor of a system, cause the system to determine that a first message addressed to a user includes text indicating that a response to the first message is sought, to configure a first notification of the first message to include information indicating that a response to the first message is sought, to cause a client device operated by the user to present the first notification including the information, to determine, after the client device has presented the first notification including the information, that the user has not responded to the first message, and to cause the client device to present a second notification of the first message based at least in part on the user having not responded to the first message.

(CRM11) At least one non-transitory computer-readable medium may be configured as described in paragraph (CRM10), and may be further encoded with additional instructions which, when executed by the at least one processor, further cause the system to configure the first notification to include information indicating that another notification of the first message will be sent if the user does not provide the response to the first message.

(CRM12) At least one non-transitory computer-readable medium may be configured as described in paragraph (CRM10) or paragraph (CRM11), and may be further encoded with additional instructions which, when executed by the at least one processor, further cause the system to determine that the user viewed content of the first notification, and to configure the first notification to include the information based at least in part on the user having viewed the content.

(CRM13) At least one non-transitory computer-readable medium may be configured as described in any of paragraphs (CRM10) through (CRM12), and t may be further encoded with additional instructions which, when executed by the at least one processor, further cause the system to determine that the user has not responded to the first message at least in part by identifying second messages sent by the user via a messaging application, and determining that none of the second messages represents the response by the user.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
determining, by a computing system, that first data received from a first system of record is indicative of a first event of the first system of record;
sending, from the computing system to a client device operated by a first user, a first notification indicative of the first event;
determining, by the computing system, that second data received from a second system of record is indicative of a second event for which the first user is to provide a response to the second system of record;
sending, from the computing system to the client device, a second notification indicative of the second event;
determining, by the computing system, that the first user has not provided the response to the second system of record; and
based at least in part on the first user not having provided the response to the second system of record, sending, from the computing system to the client device, a third notification indicative of the second event.

2. The method of claim 1, further comprising:
prior to sending the third notification to the client device, configuring, by the computing system, the second notification to include information indicating that a response to the second system of record is sought.

3. The method of claim 2, further comprising:
determining that the first user viewed content of the second notification; and
configuring the second notification to include the information based at least in part on the first user having viewed the content.

4. The method of claim 3, further comprising:
determining that a threshold period of time has elapsed after configuring the second notification to include the information; and
sending the third notification to the client device based at least in part on the threshold period of time having elapsed.

5. The method of claim 2, further comprising:
determining that a threshold period of time has elapsed after configuring the second notification to include the information; and
sending the third notification to the client device based at least in part on the threshold period of time having elapsed.

6. The method of claim 1, wherein:
the second system of record is a messaging application with which the first user has an account;
the second event comprises receipt of a first message from a second user via the messaging application; and
the second data represents the first message.

7. The method of claim 6, wherein determining that second data is indicative of the second event further comprises:
determining that text of the first message indicates that the second user has requested the response by the first user.

8. The method of claim 6, wherein determining that the first user has not provided the response to the second system of record further comprises:
receiving, by the computing system, third data received from the second system of record, the third data indicative of second messages sent by the first user via the messaging application; and
determining that none of the second messages represents the response by the first user.

9. The method of claim 1, further comprising:
determining that a threshold period of time has elapsed after sending the second notification to the client device; and
determining to send the third notification to the client device based at least in part on the threshold period of time having elapsed.

10. The method of claim 1, further comprising:
configuring, by the computing system, the second notification to include information indicating that another notification indicative of the second event will be sent if the first user does not provide the response to the second system of record.

11. A method, comprising:
determining that a first message addressed to a user includes text indicating that a response to the first message is sought;
configuring a first notification of the first message to include information indicating that a response to the first message is sought;
causing a client device operated by the user to present the first notification including the information;
after the client device has presented the first notification including the information, determining that the user has not responded to the first message; and
based at least in part on the user having not responded to the first message, causing the client device to present a second notification of the first message.

12. The method of claim 11, further comprising:
configuring the first notification to include information indicating that another notification of the first message will be sent if the user does not provide the response to the first message.

13. The method of claim 11, further comprising:
determining that the user viewed content of the first notification; and
configuring the first notification to include the information based at least in part on the user having viewed the content.

14. The method of claim 11, wherein determining that the user has not responded to the first message further comprises:
identifying second messages sent by the user via a messaging application; and
determining that none of the second messages represents the response by the user.

15. A system, comprising:
at least one processor; and
at least one computer-readable medium encoded with instruction which, when executed by the at least one processor, cause the system to:
determine that first data received from a first system of record is indicative of a first event of the first system of record,
send, to a client device operated by a first user, a first notification indicative of the first event,
determine that second data received from a second system of record is indicative of a second event for which a user is to provide a response to the second system of record,
send, to the client device, a second notification indicative of the second event,
determine that the user has not provided the response to the second system of record, and
based at least in part on the user not having provided the response to the second system of record, send, to the client device, a third notification indicative of the second event.

16. The system of claim 15, wherein the at least one computer-readable medium is further encoded with additional instructions which, when executed by the at least one processor, further cause the system to:
prior to sending the third notification to the client device, configure the second notification to include information indicating that a response to the second system of record is sought.

17. The system of claim 16, wherein the at least one computer-readable medium is further encoded with additional instructions which, when executed by the at least one processor, further cause the system to:
determine that the user viewed content of the second notification; and
configuring the second notification to include the information based at least in part on the user having viewed the content.

18. The system of claim 16, wherein the at least one computer-readable medium is further encoded with additional instructions which, when executed by the at least one processor, further cause the system to:
determine that a threshold period of time has elapsed after configuring the second notification to include the information; and
sending the third notification to the client device based at least in part on the threshold period of time having elapsed.

19. The system of claim 15, wherein the at least one computer-readable medium is further encoded with additional instructions which, when executed by the at least one processor, further cause the system to:
configure the second notification to include information indicating that another notification indicative of the second event will be sent if the user does not provide the response to the second system of record.

20. The system of claim 15, wherein:
the second system of record is a messaging application with which the first user has an account;
the second event comprises receipt of a first message from a second user via the messaging application; and
the second data represents the first message.
